(19) United States
(12) Patent Application Publication
(10) Pub. No.: US 2026/0227642 A1
(43) Pub. Date: Aug. 6, 2026

(54) HEAD-MOUNTED OPTICAL MAGNIFYING DEVICE

(71) Applicant: Far Vision Technology CO., LTD., Taichung City (TW)

(72) Inventor: Hsi-Hsun CHEN, Taichung City (TW)

(73) Assignee: Far Vision Technology CO., LTD., Taichung City (TW)

(21) Appl. No.: 19/365,769

(22) Filed: Oct. 22, 2025

(30) Foreign Application Priority Data
Feb. 3, 2025 (TW) 114201175

(51) Int. Cl. G02C 3/00; G02B 7/02; G02B 25/00; G02C 7/14

(52) U.S. Cl. CPC G02C 3/003; G02B 7/02; G02B 25/007; G02C 7/14

(57) ABSTRACT

A head-mounted optical magnifying device is adapted to be worn on a head of a user and for reflecting a magnified image of an object to eyes of the user. The head-mounted optical magnifying device includes a head frame unit, a mirror frame unit mounted to the head frame unit and including two support arms, a mirror unit, and a counterweight unit. The mirror unit is mounted to the mirror frame unit, includes objective and ocular mirror sets, and is configured to form an optical path extending from the object toward and reflected by the objective mirror set, and then extending toward and reflected by the ocular mirror set to the eyes of the user. The counterweight unit includes a head counterweight slat having a proximal end mounted to the head frame unit and a distal segment opposite to the proximal end.

### CROSS-REFERENCE TO RELATED APPLICATION

This application claims priority to Taiwanese Utility Model Patent Application No. 114201175, filed on February 3, 2025, the entire disclosure of which is incorporated by reference herein.

### FIELD

The disclosure relates to an optical device, and more particularly to a head-mounted optical magnifying device for reflecting a magnified image of an object.

### BACKGROUND

Due to the popularity of smartphones and tablet computers, the problem of vision deterioration from viewing smartphones at close range is worsening. In addition, users may tilt their heads forward in order to read text having a relatively small size displayed on their smartphones, resulting in cervical deformities. In order to solve these problems, a magnifying mirror device is used to assist users to read more easily.

For example, a conventional anti-myopia reading mirror device disclosed in Chinese Utility Model Patent No. CN 218099783 U includes a frame unit disposed on the ground, an objective mirror set mounted to a top portion of the frame unit and disposed above a desk, and an ocular mirror set facing the objective mirror set. A user may place an object such as a book on a table top of the desk, and an image of the content of the book is reflected to the user’s eyes through the optical reflection between the objective mirror set and the ocular mirror set.

However, the conventional anti-myopia reading mirror device has a relatively large volume, occupies a relatively large space, and is not convenient to use.

### SUMMARY

Therefore, an object of the present disclosure is to provide a head-mounted optical magnifying device that can alleviate at least one of the drawbacks of the prior art.

According to an aspect of the disclosure, a head-mounted optical magnifying device adapted to be worn on a head of a user and for reflecting a magnified image of an object to eyes of the user is provided. The head-mounted optical magnifying device includes a head frame unit, a mirror frame unit, a mirror unit and a counterweight unit. The head frame unit is adapted to be worn on the head of the user and to surround a periphery of the head of the user. The head frame unit includes a front frame bar adapted for abutting against a forehead of the user. The mirror frame unit is disposed in front of a front side of the head frame unit in a front-rear direction, and includes two support arms spaced apart from each other in a left-right direction transverse to the front-rear direction. The mirror unit is mounted to the mirror frame unit, and includes an objective mirror set and an ocular mirror set. The objective mirror set extends in the left-right direction and is mounted to the two support arms. The ocular mirror set is disposed in front of a front side of the objective mirror set in the front-rear direction. The mirror unit is configured to form an optical path extending from the object toward and reflected by the objective mirror set, and then extending toward and reflected by the ocular mirror set to the eyes of the user. The counterweight unit is mounted to the head frame unit, and includes a head counterweight slat that is mounted to the front frame bar. The head counterweight slat has a proximal end that is mounted to the front frame bar, and a distal segment that is opposite to the proximal end in the front-rear direction, that extends rearwardly, and that is adapted to be disposed above the head of the user in an up-down direction transverse to the front-rear direction and the left-right direction.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view of a head-mounted optical magnifying device of an embodiment according to the present disclosure worn on a head of a user for viewing an object.

FIG. 2 is a perspective view of the embodiment.

FIG. 3 is another perspective view of the embodiment seen from an angle different from FIG. 2.

FIG. 4 is a partly exploded perspective view of the embodiment.

FIG. 5 is a sectional view taken along line V-V of FIG. 1.

FIG. 6 is a sectional view taken along line VI-VI in FIG. 5, and is a fragmentary sectional view of the embodiment.

FIG. 7 is a sectional view of the embodiment.

FIG. 8 is a sectional view similar to FIG. 7, but illustrating a height of a head counterweight slat of the head-mounted magnifying device of the embodiment being changed.

FIG. 9 is a perspective view of a modification of the embodiment, illustrating a shape of the head counterweight slat being modified.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

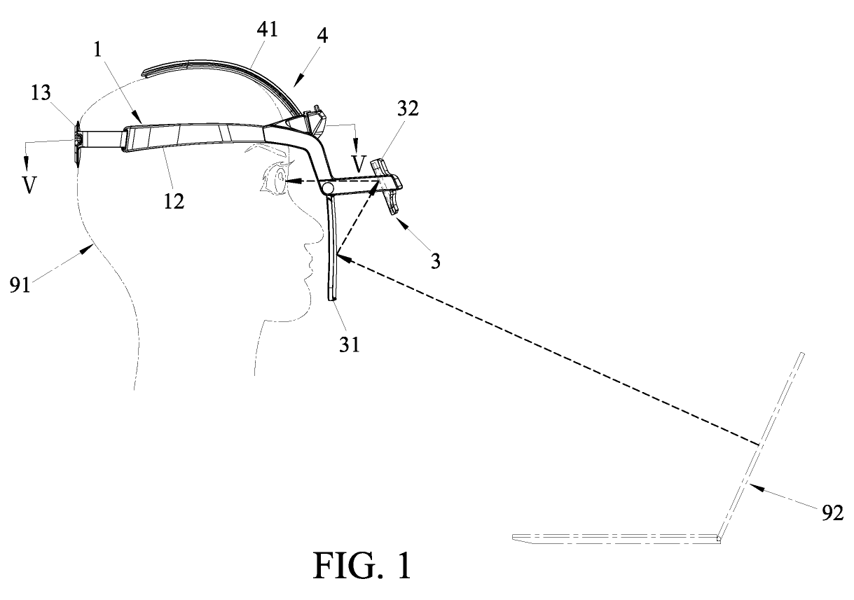

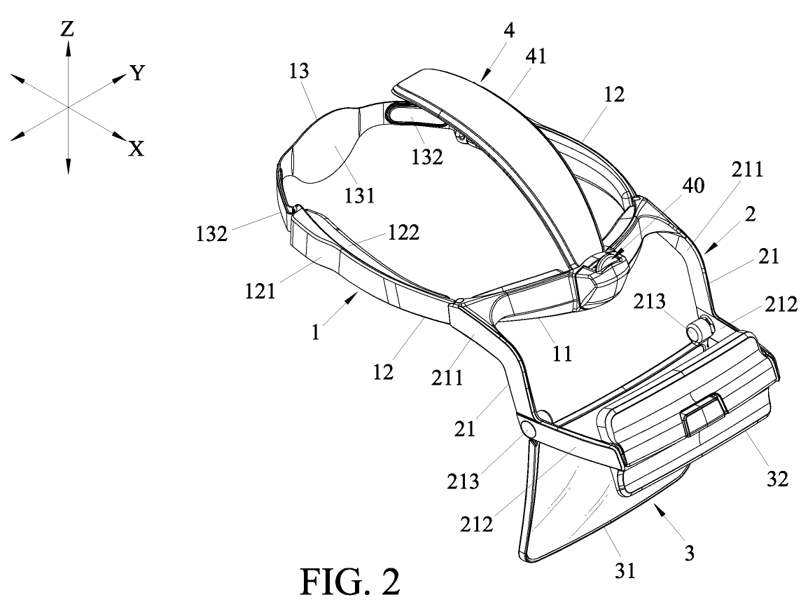

Referring to FIGS. 1 and 2, a head-mounted optical magnifying device of an embodiment according to the present disclosure is shown. The head-mounted optical magnifying device is adapted to be worn on a head of a user 91 and is for reflecting a magnified image of an object 92 to eyes of the user 91. The head-mounted optical magnifying device includes a head frame unit 1, a mirror frame unit 2, a mirror unit 3, and a counterweight unit 4.

The head frame unit 1 is adapted to be worn on the head of the user 91 and surrounds a periphery of the head of the user 91. The head frame unit 1 includes a front frame bar 11 adapted for abutting against a forehead of the user 91, two lateral frame bars 12, and a headband 13 adapted for abutting against a back of the head of the user 91.

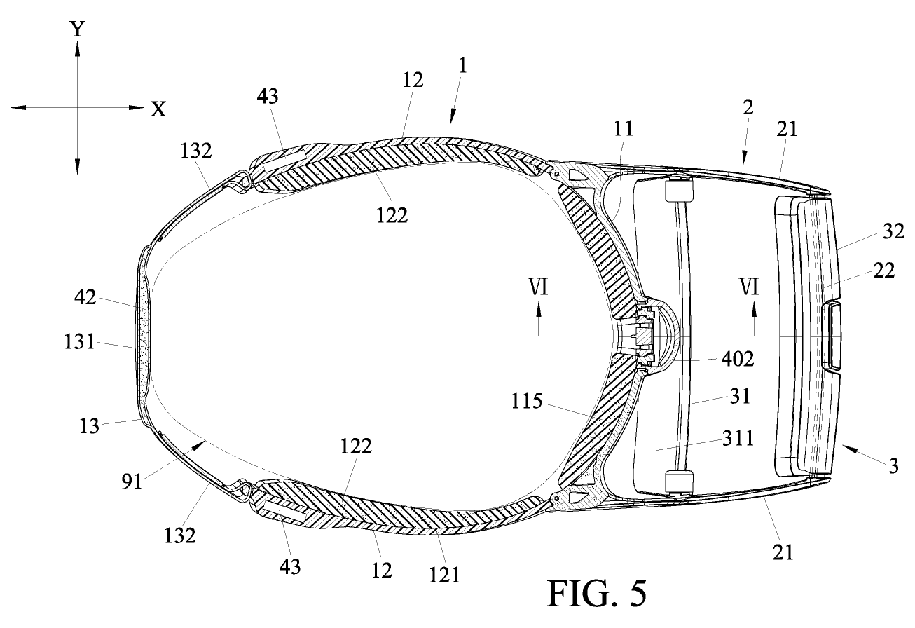

Referring to FIGS. 2 to 5, the front frame bar 11 has an intermediate portion 111, and two side portions 112 formed on the left and right sides of the intermediate portion 111 in a left-right direction (Y). The intermediate portion 111 has a groove section 113 and a threaded through hole 114 extending through the intermediated portion 111 in a front-rear direction (X) transverse to the left-right direction (Y) and formed in the groove section 113. In this embodiment, as shown in FIG. 5, the front frame bar 11 further has a pad 115 disposed on an inner side of the front frame bar 11 to thereby provide a soft touch and/or an anti-slip effect. The lateral frame bars 12 are spaced apart from each other in the left-right direction (Y), and are respectively and pivotably connected to two ends of the front frame bar 11 that are opposite in the left-right direction (Y), i.e., the two side portions 112. Each of the lateral frame bars 12 extends rearwardly from the front frame bar 11 in the front-rear direction (X). The headband 13 is connected to the lateral frame bars 12 front frame bar 11. In this way, a length of the headband 13 may be adjusted according to a circumference of the head of the user 91. By virtue of pivot connection among the lateral frame bars 12 and the front frame bar 11, and the headband 13 that is adjustable in length, the head-mounted optical magnifying device of the present disclosure may fit different head sizes to achieve a snug fit.

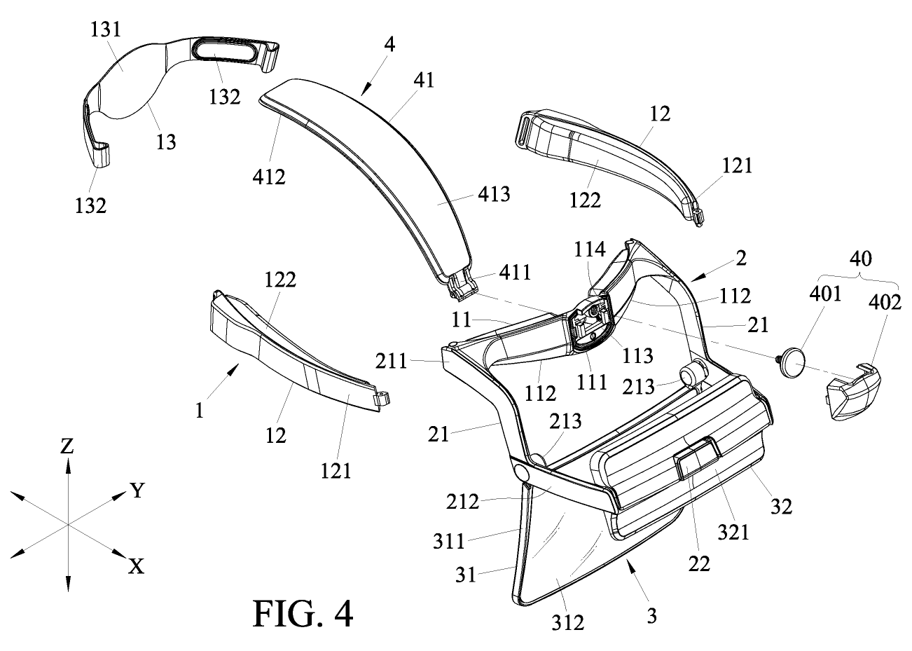

The mirror frame unit 2 is disposed in front of a front side of the head frame unit 1 in the front-rear direction (X). The mirror frame unit 2 includes two support arms 21 spaced apart from each other in the left-right direction (Y), and a mounting arm 22 extending in the left-right direction (Y) and connected to the support arms 21. Each of the support arms 21 has a connecting segment 211 connected to the front frame bar 11, an extension segment 212 connected to the connecting segment 211, and a pivot shaft 213 extending through the extension segment 212 in the left-right direction (Y). In this embodiment, as depicted in FIG. 4, the connecting segment 211 of each of the support arms 21 is integrally connected to the front frame bar 11, and extends from the front frame bar 11 forwardly and then bends downwardly. The extension segment 212 of each of the support arms 21 is integrally connected to the connecting segment 211 and extends substantially horizontally. That is to say, the support arms 21 and the front frame bar 11 are formed as a one piece.

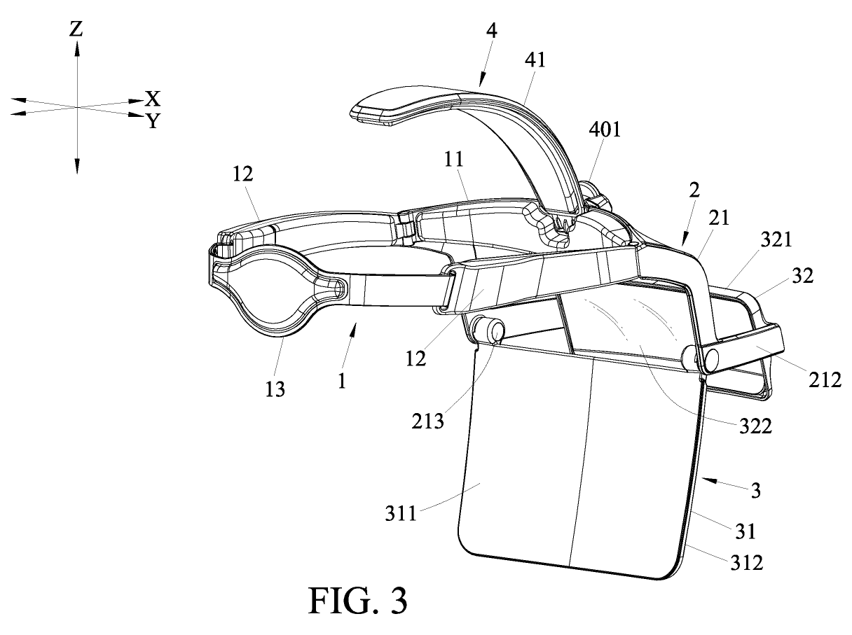

Referring to FIGS. 3 to 5, the mirror unit 3 is mounted to the mirror frame unit 2, and includes an objective mirror set 31 extending in the left-right direction (Y) and mounted to the support arms 21, and an ocular mirror set 32 disposed in front of a front side of the objective mirror set 31 in the front-rear direction (X) and mounted to the mounting arm 22 (see FIG. 5). In this embodiment, the objective mirror set 31 is pivotably connected to the pivot shafts 213 such that the objective mirror set 31 is pivotable about the pivot shafts 213 relative to the object 92 (see FIG. 1) to change a tilt degree of the objective mirror set 31 relative to the object 92. The objective mirror set 31 includes an objective mirror holder 311 pivotably mounted to the pivot shafts 213, and a reflective mirror 312 connected fixedly to an outer side of the objective mirror holder 311 and facing the object 92. The ocular mirror set 32 has an ocular mirror seat 321 mounted to the mounting arm 22, and a magnifying mirror 322 (see FIG. 3) mounted on an inner side of the ocular mirror seat 321 and facing the reflective mirror 312 of the objective mirror set 31. In some embodiments, the magnifying mirror 322 is a concave mirror and the reflective mirror 312 is a convex mirror, but are not limited hereto.

Referring back to FIG. 1, the mirror unit 3 is configured to form an optical path (P) extending from the object 92 toward and reflected by the objective mirror set 31, and then extending toward and reflected by the ocular mirror set 32 to the eyes of the user 91 to form a magnified image of the object 92. In this way, the user 91 may see the magnified image of the object 92 on the ocular mirror set 32. By virtue of the mirror unit 3 that magnifies the image of the object 92, the user 91 may easily and clearly see the magnified image and maintain a correct posture, thereby avoiding forward tilting of the head.

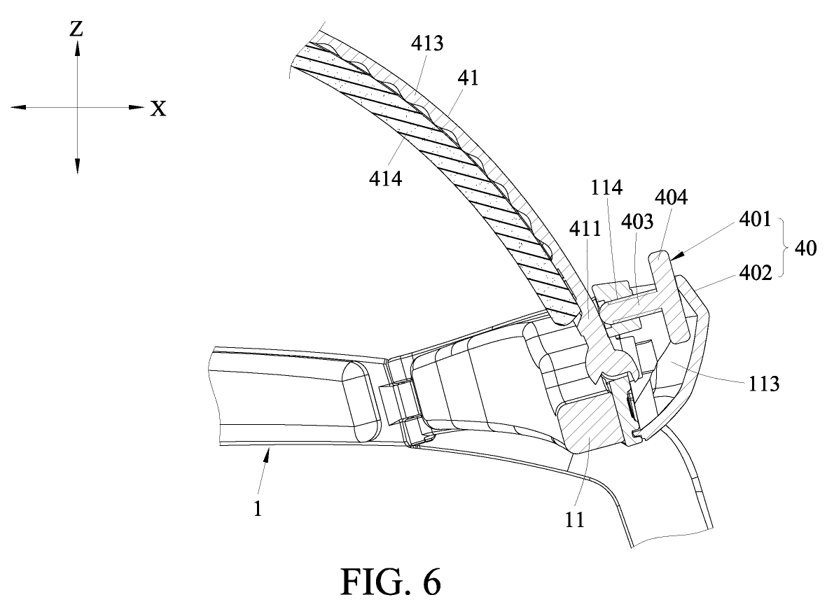

Referring to FIGS. 4 to 6, the counterweight unit 4 is mounted to the head frame unit 1, and includes a head counterweight slat 41, a first counterweight member 42, two second counterweight members 43, and an adjustment assembly 40. Since the ocular mirror set 32 has a weight greater than a weight of the objective mirror set 31, the counterweight unit 4 is provided for balancing the weight of the ocular mirror set 32 in the head frame unit 1. In this embodiment, the head counterweight slat 41 is a strip elongated in the front-rear direction (X), and has a proximal end 411 mounted on the front frame bar 11 and a distal segment 412 opposite to the proximal end 411 in the front-rear direction (X), extending rearwardly, and adapted to be disposed above the head of the user 91 in an up-down direction (Z) transverse to the front-rear direction (X) and the left-right direction (Y). In this embodiment, the head counterweight slat 41 is arc-shaped to fit a shape of the head of the user 91. The head counterweight slat 41 includes a hard sheet 413 and a soft sheet 414 disposed on an inner side of the hard sheet 413 and made of a material softer than a material of the hard sheet 413. In some embodiments, the soft sheet 414 is made of foam to increase wearing comfort, but is not limited thereto.

The first counterweight member 42 is mounted to the headband 13 and is enclosed in the belt body 131 of the headband 13 in this embodiment. In some embodiments, the first counterweight member 42 includes metal sand, but is not limited thereto. For example, in this embodiment, the first counterweight member 42 includes iron sand filled in the belt body 131. The first counterweight member 42 is disposed opposite to the mirror unit 3 in the front-rear direction (X).

The second counterweight members 43 are respectively mounted to the lateral frame bars 12. In this embodiment, each of the second counterweight members 43 is embedded in the temple 121 of the respective one of the lateral frame bars 12, but is not limited herein. For example, each of the second counterweight members 43 may be clamped between the temple 121 and the cushion 122 of the respective one of the lateral frame bars 12, or embedded in the cushion 122 of the respective one of the lateral frame bars 12. In some embodiments, each of the second counterweight members 43 includes an iron piece or an iron block.

Referring to FIGS. 1, 5, and 7, the proximal end 411 of the head counterweight slat 41 serves as a balancing point for the front frame bar 11, preventing the front frame bar 11 from sliding down due to the weight of the mirror unit 3. The first counterweight member 42 cooperates with the two second counterweight members 43 to form a three-point support at the back and lateral sides of the head of the user 91. Furthermore, the head counterweight slat 41 also balances the head frame unit 1 in the up-down direction (Z) and in the front-rear direction (X). In this way, by virtue of the arrangement of the counterweight unit 4 that counteracts the weight of the mirror unit 3, the front frame bar 11 may be stably worn on the head of the user 91 and it is relatively difficult for the head frame unit 1to slide down. Thus, a relatively comfortable and stable wearing experience may be provided even when the user 91 tilts, turns, or raises his/her head and changes his/her posture. It can be appreciated that in other embodiments, the numbers of the first counterweight member 42 and the second counterweight members 43 may be modified and positions, weights and materials of the same may also be adjusted, as long as the counterweight unit 4 is capable of counteracting the weight of the mirror unit 3 and preventing the front frame bar 11 from sliding down.

Referring to FIGS. 4, 6 and 7, the adjustment assembly 40 is mounted to the front frame bar 11 and the head counterweight slat 41, and includes an adjustment set 401 and a decorative cover 402. The adjustment set 401 includes a rod body 403, extending through the threaded through hole 114, and movable in the front-rear direction (X), and a disc body 404 connected fixedly to the rod body 403 and rotatable to move the adjustment set 401 in the front-rear direction (X). In some embodiments, the adjustment set 401 is an integrally formed component, but is not limited thereto. The rod body 403 is a threaded rod abutting against the proximal end 411 of the head counterweight slat 41. The decorative cover 402 is mounted to the front frame bar 11, is disposed in the groove section 113, and covers a lower half of the disc body 404 from a front side of the adjustment set 401. Thus, an upper half of the disc body 404 is exposed from the decorative cover 402, making it convenient for the user 91 to adjust a curvature of the head counterweight slat 41 by hand. In other embodiments, the adjustment assembly 40 may include a spring pin or other positioning fasteners.

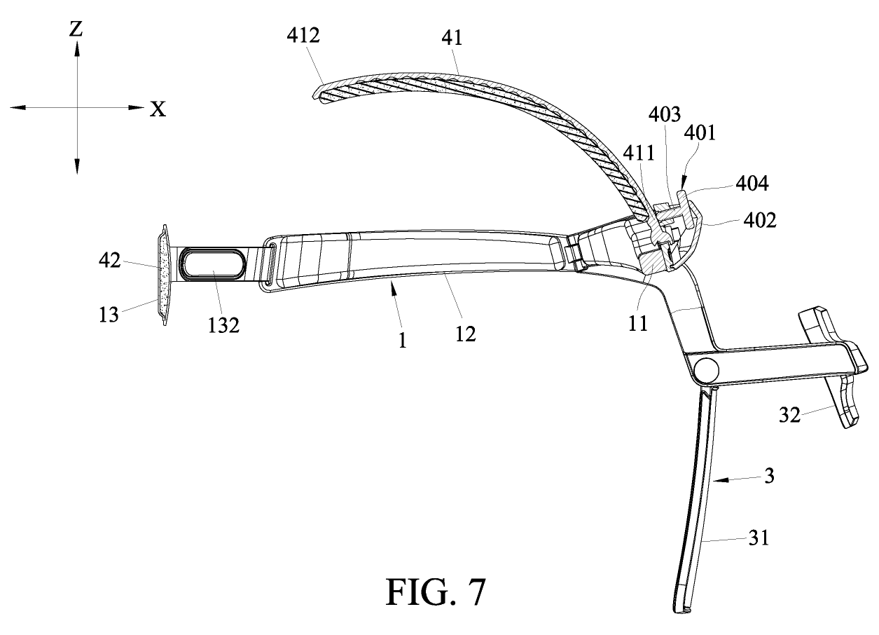

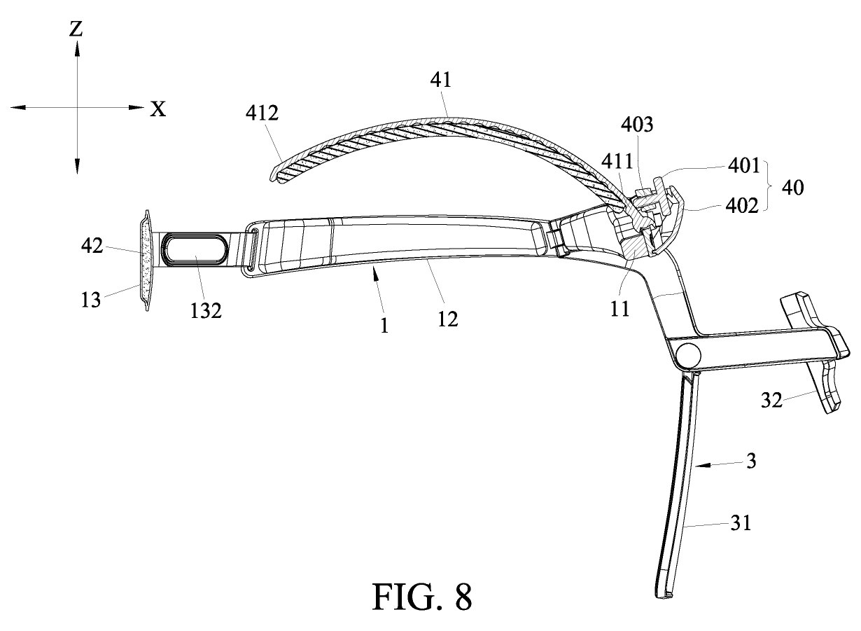

Referring to FIGS. 7 and 8, the adjustment set 401 is rotatable to drive the rod body 403 to push the proximal end 411 of the head counterweight slat 41 such that a height of the distal segment 412 of the head counterweight slat 41 in the up-down direction (Z) is changed when the rod body 403 moves in the front-rear direction (X) so the curvature of the head counterweight slat 41 is adjusted. For example, the rod body 403 of the adjustment set 401 in FIG. 8 is moved rearwardly to be closer to the first counterweight member 42 than that in FIG. 7, such that the height of the distal segment 412 of the head counterweight slat 41 in FIG. 8 is lowered to fit the shape of the head of the user 91. Thus, the user 91 may easily adjust the head counterweight slat 41 to be fitted to his/her head, thereby improving the wearing comfort. In some embodiments, the adjustment assembly 40 may be omitted from the counterweight unit 4.

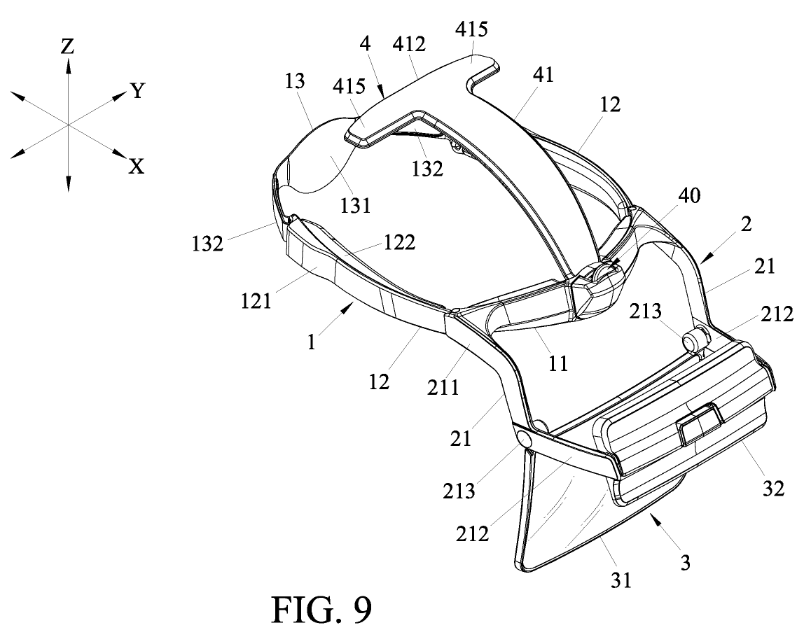

Referring to FIG. 9, a modification of the head counterweight slat 41 is shown. In this modification, the head counterweight slat 41 is T-shaped and has two wing portions 415 formed at the distal segment 412 of the head counterweight slat 41 and spaced apart from each other in the left-right direction (Y) to enhance the stability of the head-mounted optical magnifying device when worn. It should be noted that the configuration of the head counterweight slat 41 is not limited to the examples described herein as long as the counterweight unit 4 counteracts the weight of the mirror unit 3.

To sum up, the head-mounted optical magnifying device of the embodiment of the present disclosure may be stably worn on the head of the user 91, has a relatively small volume, is portable, and is convenient to use. The user 91 may simply wear the head frame unit 1 on the head to see a magnified image of the object 92 through the mirror unit 3, so the user 91 may easily maintain a proper posture. Furthermore, the weight of the mirror unit 3 is taken into account when designing the head-mounted optical magnifying device by disposition of the counterweight unit 4 that is mounted to the head frame unit 1 and that counteracts the weight of the mirror unit 3. By virtue of the proximal end 411 of the head counterweight slat 41 that serves as a balancing point for the front frame bar 11, and the adjusting set 401 that adjusts the height of the distal segment 412 of the head counterweight slat 41, tilting, deviation, or inclination of the head frame unit 1 may be effectively prevented and the stability of the head-mounted optical magnifying device when worn may be improved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A head-mounted optical magnifying device adapted to be worn on a head of a user and for reflecting a magnified image of an object to eyes of the user, said head-mounted optical magnifying device comprising:
a head frame unit that is adapted to be worn on the head of the user and to surround a periphery of the head of the user, said head frame unit including a front frame bar adapted for abutting against a forehead of the user;
a mirror frame unit that is disposed in front of a front side of said head frame unit in a front-rear direction and that includes two support arms spaced apart from each other in a left-right direction transverse to the front-rear direction;
a mirror unit that is mounted to said mirror frame unit, and that includes an objective mirror set extending in the left-right direction and mounted to said two support arms, and an ocular mirror set disposed in front of a front side of said objective mirror set in the front-rear direction, said mirror unit configured to form an optical path extending from the object toward and reflected by said objective mirror set, and then extending toward and reflected by said ocular mirror set to the eyes of the user; and
a counterweight unit that is mounted to said head frame unit, and that includes a head counterweight slat mounted to said front frame bar, said head counterweight slat having a proximal end that is mounted to said front frame bar and a distal segment that is opposite to said proximal end in the front-rear direction, that extends rearwardly, and that is adapted to be disposed above the head of the user in an up-down direction transverse to the front-rear direction and the left-right direction.

2. The head-mounted optical magnifying device as claimed in claim 1, wherein:
said head frame unit further includes two lateral frame bars and a headband;
said lateral frame bars are spaced apart from each other in the left-right direction and extend in the front-rear direction respectively from two ends of said front frame bar that are opposite in the left-right direction; and
said headband is connected to a rear portion of each of said lateral frame bars that is opposite to the front frame bar in the front-rear direction and adapted for abutting against a back of the head of the user.

3. The head-mounted optical magnifying device as claimed in claim 1, wherein:
said counterweight unit further includes an adjustment assembly mounted to said front frame bar and said head counterweight slat; and
said adjustment assembly has a rod body that abuts against said proximal end of said head counterweight slat and that is movable in the front-rear direction such that a height of said distal segment of said head counterweight slat in the up-down direction is changed when said rod body moves in the front-rear direction.

4. The head-mounted optical magnifying device as claimed in claim 3, wherein:
said rod body is a threaded rod;
said front frame bar has a threaded through hole permitting said rod body to extend therethrough and threadedly engaging said rod body;
said adjustment assembly includes an adjustment set and a decorative cover;
said adjustment set includes said rod body and a disc body fixedly connected to said rod body and rotatable to move said adjustment set in the front-rear direction;
said decorative cover is mounted to said front frame bar and covers a lower half of said adjustment set from a front side of said adjustment set.

5. The head-mounted optical magnifying device as claimed in claim 1, wherein said head counterweight slat is arc-shaped, and includes a hard sheet and a soft sheet disposed on an inner side of said hard sheet and made of a material softer than a material of said hard sheet.

6. The head-mounted optical magnifying device as claimed in claim 2, wherein said counterweight unit further includes a first counterweight member mounted to said headband.

7. The head-mounted optical magnifying device as claimed in claim 6, wherein said first counterweight member includes metal sand.

8. The head-mounted optical magnifying device as claimed in claim 2, wherein said counterweight unit further includes two second counterweight members respectively mounted to said lateral frame bars.

9. The head-mounted optical magnifying device as claimed in claim 8, wherein each of said two second counterweight members includes one of an iron piece and an iron block.

10. The head-mounted optical magnifying device as claimed in claim 1, wherein:
each of said two support arms includes a connecting segment connected to said front frame bar, an extension segment connected to said connecting segment, and a pivot shaft extending through said extension segment;
said objective mirror set is pivotably mounted to said pivot shafts of said two support arms;
said mirror frame unit further includes a mounting arm extending in the left-right direction, and connected to said extension segment of each of said two support arms; and
said mounting arm is provided for said ocular mirror set to be mounted thereto.

11. The head-mounted optical magnifying device as claimed in claim 1, wherein said head counterweight slat is T-shaped and has two wing portions formed at said distal segment of said head counterweight slat and spaced apart from each other in the left-right direction.
